(19) United States
(12) Patent Application Publication
(10) Pub. No.: US 2025/0358105 A1
(43) Pub. Date: Nov. 20, 2025

(54) GROUP KEY SHARING

(71) Applicant: Arqit Limited, London (GB)

(72) Inventors: Andrew Yeomans, Greater London (GB); Daryl Burns, Gloucestershire (GB)

(21) Appl. No.: 18/873,584

(22) PCT Filed: Jun. 13, 2023
(86) PCT No.: PCT/GB2023/051530

§ 371 Date: Dec. 10, 2024

(30) Foreign Application Priority Data
Jun. 14, 2022 (GB) 2208692.0

(51) Int. Cl. H04L 9/08

(52) U.S. Cl. CPC H04L 9/0833; H04L 9/0822; H04L 9/0827; H04L 9/0852

(57) ABSTRACT

The present disclosure provides methods systems and apparatuses for use in the secure agreement of group keys in which the group key(s) are shared between multiple end-point devices, said multiple-endpoint devices being used to create the group key(s) that is/are distributed in such a manner that no other untrusted part of the system has access to sufficient information to be able to derive or determine the group key(s) and/or portions of said group key(s). This is achieved by pairs of endpoint devices agreeing pairwise keys between themselves, wherein an intermediary device that distributes encryption keys to the endpoint devices over quantum communication channels does not have sufficient information to be able to derive the identity of the pairwise keys.

### FIELD OF THE INVENTION

The present application relates to a system, apparatus and method for secure communications based on quantum key exchange/distribution (QKD) protocols for QKD group key sharing, using multiple pairwise keys and/or applications thereto.

### BACKGROUND TO THE INVENTION

Quantum Key Distribution (QKD) is a secure communication method which implements a cryptographic QKD protocol involving components of quantum mechanics for distributing cryptographic keys. It enables two parties to produce a shared random secret key or cryptographic key known only to them, which can then be used to encrypt and decrypt messages. Following the arrival of large-scale quantum computers, classical (e.g., factorisation and discrete-log based) key exchange methods for key agreement will be vulnerable and unable to provide security. Post-quantum algorithms offer an alternative but suffer from the possibility of yet-to-be-discovered mathematical attacks on their foundations. QKD offers unconditionally-secure agreement of keys between two parties which possess an initial amount of shared secret material but, due to its reliance on physical implementations, the possibility of malfunctions or physical attacks remains.

The BB84 QKD protocol is a well-known QKD protocol using photon polarisation bases to transmit information. The BB84 QKD protocol uses a set of bases including at least two pairs of conjugate photon polarisation bases—for example a set of bases including a rectilinear photon basis (e.g. vertical) (0° and horizontal) (90° polarisations) and a diagonal photon basis (e.g. 45° and 135° polarisations) or the circular basis of left- and right-handedness or similar. In the BB84 protocol, QKD is performed between a sender device or intermediary device, hereinafter referred to as Alice, and a receiver or first device, hereinafter referred to as Bob or Carol in different implementations. The sender device and receiver device are connected by a quantum communication channel that allows quantum information such as quantum states to be transmitted. Further, the sender device and receiver device also communicate over a non-quantum channel, i.e., a (public) classical channel.

In an example implementation, Sheng-Kai Liao et al., “Satellite-to-ground quantum key distribution”, Nature, vol. 549, pp 43-47, 7 Sep. 2017, describes a satellite-based QKD system using the BB84 protocol for distributing keys, where a satellite free-space optical quantum channel is produced using a 300-mm aperture Cassegrain telescope that sends a light beam from a Micius satellite (operating as Alice in this scenario) to a ground station (operating as Bob in this scenario), the ground station using a Ritchey Chretien telescope for receiving the QKD photons over the satellite free-space optical quantum channel.

Although the security of the BB84 protocol comes from judicious use of the quantum and classical communication channels and suitable authentication processes, both the sender (or intermediary device) distributing the cryptographic key and the receiver receiving the cryptographic key know the cryptographic key that the receiver device will eventually use. This means that the sender (or intermediary) distributing the cryptographic key to the receiver has to be a trusted device in a secure location in order for the receiver to be able to trust that they can use the resulting cryptographic key securely. This may be possible in situations where both the sender and receiver use the resulting cryptographic key for cryptographic operations between themselves—for example, for encrypted communications with each other. However, if the sender (or intermediary) is only distributing keys to one or more receivers where each of the receivers intends to use their received cryptographic keys for communication with one or more other receiver devices, then it may not be acceptable—from a security perspective—for the sender (or intermediary) to have access to the resulting cryptographic keys as this would result in an insecure system that cannot be trusted. These issues may be further exacerbated in the context of group messaging in a group of more than two devices where a single group key is shared multiple times.

Additionally, in the context of group key sharing, implementing group key sharing can be an operation that ranges from trivially simple to incredibly complex, depending on the configuration of the cryptographic system and the assumptions made in the key agreement and sharing processes. A particular challenge facing any group key distribution system is that of authenticating each of the entities (people and/or systems) within the group, and then securely setting up the required encrypted channels between the entities. If suitable authentication and control processes are not in place, then group members cannot reasonably be expected to trust the group. This issue may be particularly prevalent in commercial group systems such as Whatsapp® group messaging in which anyone in a group may invite others to the group. Changes to a group's membership in such systems may occur without permission being sought from each of the members of the group which, in many implementations, may represent a significant security risk.

Therefore, it is clear that there is a desire for an improved secure group communication system that leverages the advantages of QKD and post-quantum cryptographic algorithms in a more secure manner than previously achieved. There is also a desire for a group key sharing system that is capable of sharing identical cryptographic keys between multiple end-points without allowing any other (untrusted) parts of the system to have access to the shared key, or to portions of said key. Furthermore, there is a desire for a group key sharing system that does not rely on the intermediary device being a fully trusted device, i.e., a system where the intermediary device does not need to be fully trusted by all of the devices in the group. In other words, there is a need for a system where the intermediary device does not have enough information to be able to derive or determine the group key shared between the multiple end-point devices.

The invention of the present disclosure builds upon the inventions devised and disclosed in GB2590064B, the entirety of which is hereby incorporated by reference.

The inventors have devised the claimed invention in light of the above considerations.

The embodiments described below are not limited to implementations which solve any or all of the disadvantages of the known approaches described above.

### SUMMARY OF INVENTION

This Summary is provided to introduce a selection of concepts in a simplified form that are further described below in the Detailed Description. This Summary is not intended to identify key features or essential features of the claimed subject matter; variants and alternative features which facilitate the working of the invention and/or serve to achieve a substantially similar technical effect should be considered as falling into the scope of the invention.

In a general sense, the present disclosure provides methods systems and apparatuses for use in the secure agreement of group keys in which the group key(s) are shared between multiple end-point devices, said multiple-endpoint devices being used to create the group key(s) that is/are distributed in such a manner that no other untrusted part of the system has access to sufficient information to be able to derive or determine the group key(s) and/or portions of said group key(s).

The invention is defined as set out in the appended set of claims.

In a first aspect of the present invention, there is provided a computer-implemented method of generating a group key for a group of endpoint devices in a communication system comprising the group of endpoint devices and an intermediary device. The intermediary device is communicatively linked to each of the endpoint devices by a respective quantum communication channel and a respective classical communication channel. The method comprises: sending, from the intermediary device to each of the endpoint devices, over the corresponding quantum communication channel a respective encryption key. Said respective encryption key is defined by a string of bits, wherein each bit of each encryption key is transmitted in a randomly selected basis state such that for each encryption key there is a corresponding set of transmitting bases indicative of the basis in which each bit of said encryption key was sent to the corresponding endpoint device. The method further comprises receiving, at each endpoint device, the respective encryption key, wherein each bit of the respective received encryption key is received in a randomly selected basis state such that there is a corresponding set of receiving bases indicative of the basis in which each bit of the respective received encryption key was received by the corresponding endpoint device. The method further comprises: sending, from the intermediary device to each of the endpoint devices, over the corresponding classical communication channel the respective set of transmitting bases corresponding to the respective encryption key; determining, by each endpoint device, a set of bits of the encryption key that were validly received based on a combination of the respective set of transmitting bases and the respective set of receiving bases; determining, by one of the endpoint devices, a group key, K₀; and iteratively distributing the group key. Each iteration of the distributing comprises: agreeing, between an endpoint device in possession of the group key and another endpoint device not in possession of the group key, a respective pairwise encryption key, encrypting, by said endpoint device in possession of the group key, a copy of the group key with the respective pairwise encryption key, and sending, from said endpoint device in possession of the group key to said endpoint device not in possession of the group key, the encrypted copy of the group key. The agreeing of the pairwise encryption key is based on: the respective sets of transmitting bases corresponding to each of the endpoint device in possession of the group key and the endpoint device not in possession of the group key, the respective sets of receiving bases corresponding to each of the endpoint device in possession of the group key and the endpoint device not in possession of the group key, and the respective encryption keys received by each of the endpoint device in possession of the group key and the endpoint device not in possession of the group key.

In some embodiments, determining the set of bits of the encryption key that were validly received may comprise: combining the respective set of transmitting bases and the respective set of receiving bases by performing an XOR operation between the set of transmitting bases and the set of receiving bases.

In some embodiments agreeing, between a first and second endpoint device, a pairwise encryption key may comprise: receiving, at the second endpoint device from the intermediary device, pairwise key information. The pairwise key information may be based on: information associated with the encryption key sent from the intermediary device to the first endpoint device, and information associated with the encryption key sent from the intermediary device to the second endpoint device. The agreeing may further comprise: determining, at the second endpoint device, an intermediate key based on the pairwise key information and the respective encryption key received from the intermediary device by the second endpoint device; exchanging, between the first and second endpoint devices, over a communication channel communicatively linking the first and second endpoint devices, the respectively determined set of bits of the corresponding encryption key that were validly received by each of the endpoint devices; discarding, by the first endpoint device, bits from the respective encryption key received from the intermediary device that are in positions within the respective encryption key corresponding to the positions of the bits in their respective encryption keys that were not validly received by either the first endpoint device or the second endpoint device to obtain a first copy of the pairwise encryption key; and discarding, by the second endpoint device, bits from the intermediate key that are in positions within the intermediate key corresponding to the positions of the bits in their respective encryption keys that were not validly received by either the first endpoint device or the second endpoint device to obtain a second copy of the pairwise encryption key.

In some embodiments, the pairwise key information may comprise a combination of information indicative of the encryption key sent to the first endpoint device by the intermediary device and information indicative of the encryption key sent to the second endpoint device by the intermediary device.

In some embodiments, the combination of information indicative of the encryption key sent to the first endpoint device by the intermediary device and information indicative of the encryption key sent to the second endpoint device by the intermediary device may comprise a bit string obtainable by performing an XOR operation between the encryption key sent to the first endpoint device and the encryption key sent to the second endpoint device.

In some embodiments, determining the intermediate key, by the second endpoint device, may comprise combining the respective encryption key received from the intermediary device with the pairwise key information received from the intermediary device.

In some embodiments, combining the respective encryption key received by the second endpoint device with the pairwise key information received from the intermediary device may comprise performing an XOR operation between said encryption key and the pairwise key information.

In some embodiments, the method may further comprise, after exchanging the respectively determined set of bits of the corresponding encryption key that were validly received by each of the endpoint devices: determining, by each of the first and second endpoint device, a set of positions within the respective encryption key or intermediate key, corresponding to one or both of: (i) positions within the encryption key received by the first endpoint device from the intermediary device that are the positions of bits in said encryption key that were not validly received by the first endpoint device; and (ii) positions within the encryption key received by the second endpoint device from the intermediary device that are the positions of bits in said encryption key that were not validly received by the second endpoint device. The discarding, by each of the endpoint devices, of bits from the respective encryption key or intermediate key may comprise discarding bits that are in the determined set of positions.

In some embodiments, determining the set of positions may comprise performing a non-exclusive combination of the determined set of bits of the encryption key received by the first endpoint device that were validly received with the determined set of bits of the encryption key received by the second endpoint device that were validly received.

In some embodiments, the non-exclusive combination may be a logical OR operation.

In some embodiments, a bit may be determined as being validly received if it was received in the same basis as the basis in which it was transmitted by the intermediary device.

In some embodiments, each quantum communication channel may be a lossy channel, and the method may further comprise: sending, from each of the endpoint devices, a respective indication of which bits of the respective encryption key were successfully transmitted over the corresponding quantum communication channel; and before sending the respective set of transmitting bases from the intermediary device to each of the endpoint devices, modifying the respective encryption key by discarding bits corresponding to those bits that were not successfully transmitted over the quantum communication channel, such that all further operations by the intermediary device based on the respective encryption key are based on the modified respective encryption key.

In another aspect, there is provided a computer-implemented method for generating a group key for a group of endpoint devices in a communication system. The method is performable by an intermediary device communicatively linked to each of the endpoint devices by a respective quantum communication channel and a respective classical communication channel. The method comprises: sending, to each of the endpoint devices, over the corresponding quantum communication channel, a respective encryption key. Said respective encryption key is defined by a string of bits; wherein each bit of each encryption key is transmitted in a randomly selected basis state such that for each encryption key there is a corresponding set of transmitting bases indicative of the basis in which each bit of said encryption key was sent to the corresponding endpoint device. The method further comprises sending, to each of the endpoint devices, over the corresponding classical communication channel, the respective set of transmitting bases corresponding to the respective encryption key.

In some embodiments, as part of a pairwise encryption key agreement process for distributing a group key between the endpoint devices, the method may further comprise: sending, to an endpoint device not in possession of the group key. The pairwise key information may be based on: information associated with the encryption key sent from the intermediary device to an endpoint device that is in possession of the group key, and information associated with the encryption key sent from the intermediary device to the endpoint device not in possession of the group key.

In some embodiments, the pairwise key information may comprise a combination of information indicative of the encryption key sent to the endpoint device that is in possession of the group key and information indicative of the encryption key sent to the endpoint device that is not in possession of the group key.

In some embodiments, the combination may be obtainable by performing an XOR operation between the encryption key sent to the endpoint device that is in possession of the group key and the endpoint device that is not in possession of the group key.

In some embodiments, each quantum communication channel may be a lossy channel, and the method may further comprise: receiving from each endpoint device, a respective indication of which bits of the respective encryption key were successfully transmitted over the corresponding quantum communication channel; and before sending the respective set of transmitting bases to each of the endpoint devices, modifying the respective encryption key by discarding bits corresponding to those bits that were not successfully transmitted over the quantum communication channel, such that all further operations by the intermediary device based on the respective encryption key are based on the modified respective encryption key.

In another aspect there is provided a computer-implemented method for generating a group key for a group of endpoint devices in a communication system. The method is performable by an endpoint device in the group, said endpoint device being communicatively linked to an intermediary device by a quantum communication channel and a classical communication channel. The method comprises: receiving, from the intermediary device, over the quantum communication channel, an encryption key. The encryption key is defined by a string of bits, wherein each bit of the encryption key is transmitted in a randomly selected basis state such that there is a corresponding set of transmitting bases indicative of the basis in which each bit of the encryption key was sent to the endpoint device, and wherein each bit of the encryption key is received in a randomly selected bases state such that there is a corresponding set of receiving bases indicative of the basis in which each bit of the encryption key was received by the endpoint device. The method further comprises: receiving, from the intermediary device, over the classical communication channel, the set of transmitting bases corresponding to the encryption key; determining a set of bits of the encryption key that were validly received based on a combination of the set of transmitting bases and the set of receiving bases; optionally, determining a group key, K₀; and either: if not in possession of the group key: agreeing with a further endpoint device in the group of endpoint devices in possession of the group key, a pairwise encryption key, and receiving from the further endpoint device, an encrypted copy of the group key, encrypted with the pairwise encryption key; or: if in possession of the group key: iteratively distributing the group key. Each iteration of the distributing comprises: agreeing, with respectively further endpoint devices in the group of endpoint devices that are not in possession of the group key, a respective pairwise encryption key, encrypting a copy of the group key with the respective pairwise encryption key, and sending, to the respective further endpoint device, the respective encrypted copy of the group key. The agreeing of the pairwise encryption key is based on: the respective sets of transmitting bases corresponding to each of the endpoint device in possession of the group key and the endpoint device not in possession of the group key, the respective sets of receiving bases corresponding to each of the endpoint device in possession of the group key and the endpoint device not in possession of the group key, and the respective encryption keys received by each of the endpoint device in possession of the group key and the endpoint device not in possession of the group key.

In some embodiments, determining the set of bits of the encryption key that were validly received may comprise: combining the set of transmitting bases and the set of receiving bases by performing an XOR operation between the set of transmitting bases and the set of receiving bases.

In some embodiments, agreeing between the endpoint device and the respective further endpoint device, a pairwise encryption key may comprises: exchanging, with the further endpoint device, over a communication channel communicatively linking the endpoint device with the further endpoint device, the determined set of bits of the encryption key that were validly received by the endpoint device and a further set of bits of the further encryption key that were determined by the further endpoint device as being validly received by the further endpoint device from the intermediary device; and if the endpoint device is not in possession of the group key: receiving, from the intermediary device, pairwise key information The pairwise key information may be based on: information associated with a further encryption key sent from the intermediary device to the further endpoint device, and information associated with the encryption key received from the intermediary device. The method may further comprise: determining an intermediate key based on the pairwise key information and the received encryption key; and discarding bits from the intermediate key that are in positions within the intermediate key corresponding to the positions, within one or both of the encryption key and the further encryption key, of the bits that were not validly received by either or both of the endpoint device and the further endpoint device, to obtain a copy of the pairwise encryption key. Or, if the endpoint device is in possession of the group key, the method may further comprise: discarding bits from the received encryption key that are in positions within the encryption key corresponding to the positions, within one or both of the encryption key and the further encryption key, of the bits that were not validly received by either or both of the endpoint device and the further endpoint device, to obtain a copy of the pairwise encryption key.

In some embodiments, the pairwise key information may comprise a combination of information indicative of the encryption key sent to the endpoint device by the intermediary device and information indicative of the further encryption key sent to the further endpoint device by the intermediary device.

In some embodiments, the combination of information indicative of the encryption key sent to the endpoint device by the intermediary device and information indicative of the further encryption key sent to the further endpoint device by the intermediary device may comprise a bit string obtainable by performing an XOR operation between the encryption key sent to the endpoint device and the further encryption key sent to the further endpoint device.

In some embodiments, determining the intermediate key may comprise combining the received encryption key with the pairwise key information.

In some embodiments, combining the received encryption key with the pairwise key information may comprise performing an XOR operation between the received encryption key and the pairwise key information.

In some embodiments, the method may further comprise, after exchanging the respectively determined set of bits of the corresponding encryption key that were validly received by each of the endpoint device and the further endpoint device: determining a set of positions within the encryption key or intermediate key corresponding to one or both of: (i) positions within the encryption key received by the endpoint device that are the positions of bits in said encryption key that were not validly received by the endpoint device; and (ii) positions within the further encryption key received by the further endpoint device from the intermediary device that are the positions of bits in said further encryption key that were not validly received by the further endpoint device. The discarding of bits from the encryption key or the intermediate key may comprise discarding bits that are in the determined set of positions.

In some embodiments, determining the set of positions may comprise performing a non-exclusive combination of the determined set of bits of the encryption key received by the endpoint device that were validly received with the further determined set of bits of the further encryption key received by the further endpoint device that were validly received.

In some embodiments, the non-exclusive combination may be a logical OR operation.

In some embodiments, a bit may be determined as being validly received if it was received in the same basis as the basis in which it was transmitted by the intermediary device.

In some embodiments, the quantum communication channel may be a lossy channel, and the method may further comprise: sending, to the intermediary device, an indication of which bits of the encryption key were successfully transmitted over the quantum communication channel.

In some embodiments, the randomly selected basis states in which bits are transmitted and/or received may comprise one or more of: a rectilinear basis, a diagonal basis, and a circular basis.

In some embodiments, the randomly selected basis states in which bits are transmitted and/or received may comprise orthogonal, and optionally orthonormal, basis states.

In some embodiments, each encryption key sent from the intermediary device to the or each endpoint device may be a randomly generated string of bits.

In some embodiments, the intermediary device may be on-board a satellite.

In some embodiments, one or more of the endpoint devices may be ground user stations.

In some embodiments, one or more of the endpoint devices may comprise optical ground receivers.

In another aspect, there is provided a computing device comprising a processor configured to carry out the methods disclosed herein.

In another aspect there is provided a networked computing system comprising a plurality of computing devices as disclosed herein, wherein the system is configured to carry out the methods disclosed herein.

In another aspect, there is provided a computer program product comprising logic that, when executed by one or more computers, causes the one or more computers to carry out the methods disclosed herein.

In another aspect there is provided a computer-readable medium comprising instructions that, when executed by one or more computers cause the one or more computers to carry out the methods disclosed herein.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is issued for designing silicon chips, or for configuring universal programmable chips, to carry out desired functions.

The features and embodiments discussed above may be combined as appropriate, as would be apparent to a person skilled in the art, and may be combined with any of the aspects of the invention except where it is expressly provided that such a combination is not possible or the person skilled in the art would understand that such a combination is self-evidently not possible.

### BRIEF DESCRIPTION OF THE DRAWINGS

Embodiments of the present invention are described below, by way of example, with reference to the following drawings.

FIG. 1 is a schematic diagram illustrating an example QKD system for group key sharing according to some embodiments of the invention.

FIG. 2 is a schematic diagram illustrating a satellite QKD (SQKD) system for group key sharing.

FIG. 3 is a schematic diagram illustrating the agreement of a pairwise key between two endpoint devices, such as those depicted in FIG. 2.

FIG. 4 is a flow diagram illustrating a QKD group key sharing process for use in the SQKD system of FIG. 2.

FIG. 5 is a flow diagram illustrating a pairwise key agreement process for use between the endpoint devices of FIG. 3.

FIG. 6 is a schematic diagram illustrating an example computing device configured to implement the methods described herein.

Common reference numerals are used throughout the figures to indicate the same or similar features.

### DETAILED DESCRIPTION

Embodiments of the present invention are described below by way of example only. These examples represent the best mode of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

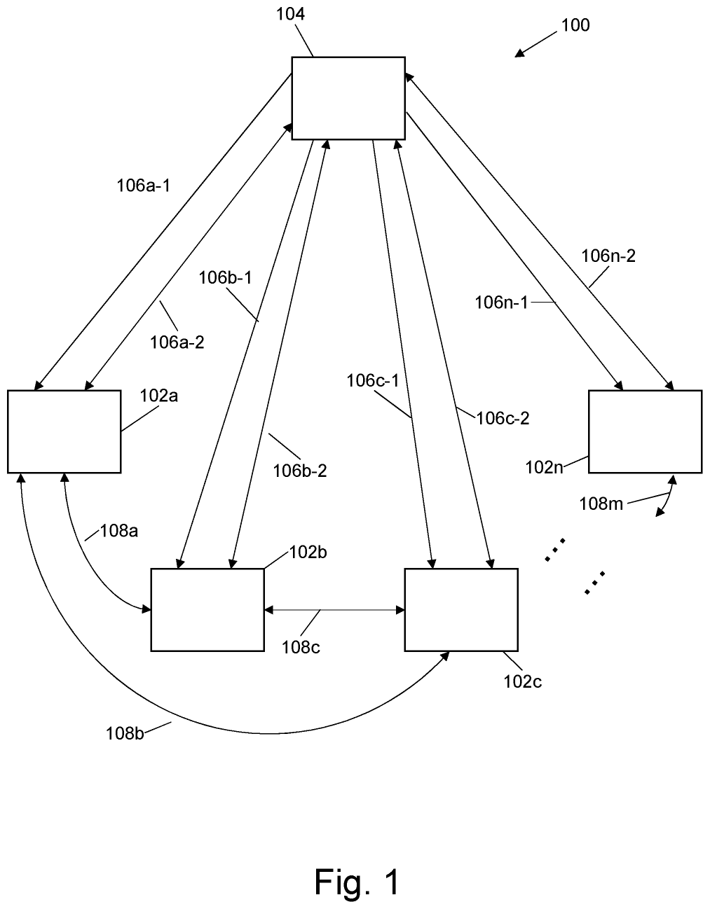

FIG. 1 is a schematic diagram illustrating an example QKD system 100 for group key sharing. The system 100 comprises a plurality of endpoint devices 102a-102n and an intermediary device 104. The plurality of endpoint devices 102a-102n define a group of devices having a number, N, of members—being at least more than two members (i.e., N>2). The intermediary device 104 may be, for example, a satellite or another telecommunications network device/apparatus. The intermediary device 104 is configured to communicate with each of the plurality of endpoint devices 102a-102n over respective quantum communication channels 106a-1 to 106n-1 and respective classical communication channels 106a-2 to 106n-2. In other words, each endpoint device 106a to 106n is communicatively linked to the intermediary device 104 by a respective quantum communication channel 106a-1 to 106n-1 and by a respective classical communication channel 106a-2 to 106n-2. Additionally, each of the endpoint devices 102a-102n is respectively configurable to communicate with each of the other endpoint devices 102a-102n in the group via respective inter-endpoint classical communication channels 108a-108m.

The plurality of inter-endpoint classical communication channels 108a-108m may be used to enable the group of endpoint devices 102a-102n to securely communicate using a shared group key, and to perform key exchange operations during the determination/derivation/agreement of the shared group key.

The intermediary device 104 is configurable to perform a QKD protocol for transmitting respective QKD keys to each of the endpoint devices 102a-102n over the corresponding quantum communication channel 106a-1 to 106n-1. The QKD protocol may provide authentication and an assurance of confidentiality for the details (i.e., the precise identity) of the QKD keys. Each of the quantum communication channels 106a-1 to 106n-1 may be, for example, an optical channel. In such an example, each of the endpoint devices 102a-102n includes the functionality of an optical receiver capable of receiving quantum signals. The received quantum signals may represent a random key transmitted over the corresponding quantum communication channels 106a-1 to 106n-1.

In the QKD system 100, the intermediary device 104 is configured to use a corresponding QKD protocol to send a different random QKD key to each of the endpoint devices 102a-102n in the group, together with particular group key information to a plurality of the endpoint devices 102a-102n. The nature of the group key information will be discussed in further detail below. In some implementations, the intermediary device 104 may send the group key information to all of the endpoint devices 102a-102n apart from a first endpoint device 102a representing a so-called first member of the group. The group key information sent to each of the endpoint devices may be respectively different

In order to successfully share a group key, the intermediary device 104 is configured to generate a first random key, K₁, and transmit the first random key over the first quantum communication channel 106a-1 to the first endpoint device 102a (i.e., n=1, so the 1^{st} endpoint device).

The intermediary device 104 is further configured to, simultaneously or subsequently, for each of the other endpoint devices 102b-102n in the group, generate another (n^{th}) random key, Kₙ, and transmit each of the random keys to a respective endpoint device 102b-102n over a corresponding quantum communication channel 106b-1 to 106n-1.

The transmission of each of the random keys over respective quantum communication channels 106a-1 to 106n-1 according to a QKD protocol such as the one described in more detail below achieves quantum key distribution based each of the random keys to their respective endpoint devices 102a-102n. In other words, each of the randomly generated keys, Kₙ, is a precursor to a QKD key. Further, the agreement of each of the QKD keys may include not just the transmission of the each of the random over the corresponding quantum communication channels 106a-1 to 106a-n but may also include the transmission of basis sets, and error detection and correction over either the corresponding quantum communication channel 106a-1 to 106n-1 and/or the corresponding classical communication channel 106a-2 to 106n-2. Such communications may follow a protocol such as the BB84 protocol or other protocols, such as those devised by the inventors.

In order to establish a group key between each of the endpoint devices 102a-102n, the intermediary device 104 may be further configured to transmit additional, or ancillary information to each of the endpoint devices 102a-102n over the respective classical communication channel 106b-1 to 106b-n. This additional information may be referred to herein as respective group key information. The group key information sent to each of the endpoint devices 102a-102n may be encrypted in such a way that only the endpoint device that is the intended recipient of the group key information is able to decrypt and read the respective group key information.

Various levels of security may be achieved depending on how the respective random keys and corresponding group key information are configured and/or transmitted/exchanged between the intermediary device 104 and the endpoint devices 102a-102n. For example, the intermediary device 104 may be considered to be an untrusted device. In such scenarios, when following the group key distribution protocol, the intermediary device 104 will never be privy to sufficient information to be able to derive the group key. As will be discussed in more detail below, a benefit derived from the methods described herein is that the intermediary device 104 is never able to derive the identity of the group key and, further, does not have sufficient information to be able to derive the identity of any of the QKD keys agreed upon by each of the endpoint devices 102a-102n.

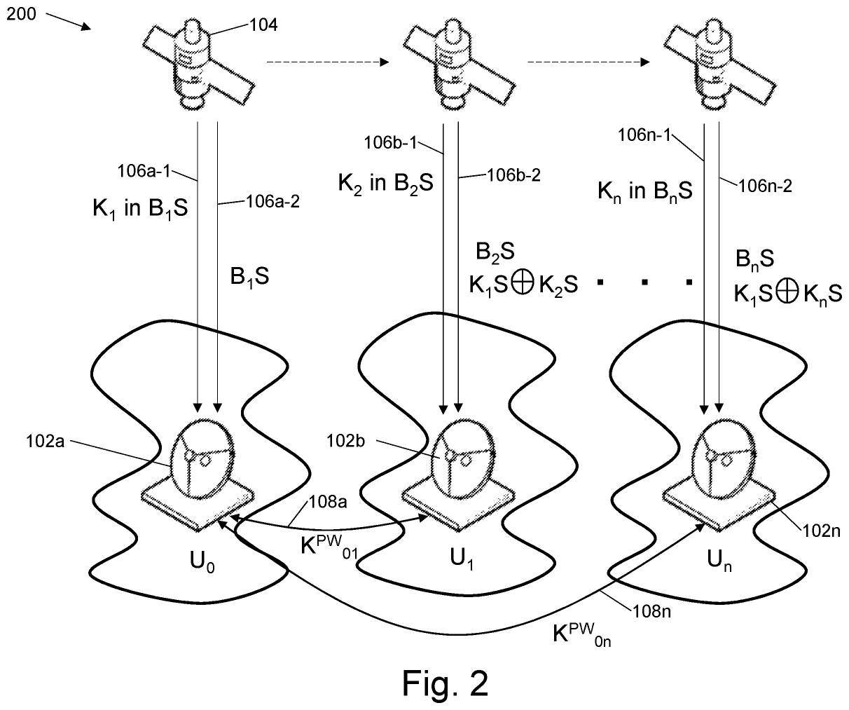

FIG. 2 is a schematic diagram illustrating an SQKD system 200 for group key sharing.

In the example shown in FIG. 2, a plurality of endpoint devices 102a-102n are associated with a plurality of user stations that form a group. The plurality of user stations may be geographically and/or logically distinct from one another. In the example shown in FIG. 2, the intermediary device 104 is a satellite. Said satellite need not be a trusted member of the group of endpoint devices 102a-102n. In some examples, the intermediary device 104 is a single satellite that passes over each of the user stations 102a-102n in turn during its orbit. In other examples, the intermediary device 104 may be a group (or constellation) of satellites in communication with each other and respectively in communication with different subsets of the user stations 102-102n. Different satellites may both be in communication with the same user station, or each user station may be in communication with just one satellite from the constellation of satellites.

As discussed above, the satellite(s) is/are configured to communicate with each of the user stations 102a-102n over respective quantum communication channels 106a-1 to 106n-1 and respective classical communication channels 106a-2 to 106n-2. These communication channels may, for example, be optical channels. In such implementations, each of the user stations 102a-102n may therefore include an optical ground receiver (OGR). Additionally each of the endpoint devices/user stations 102a-102n are configured to communicate with one another over respective communication channels. For example, the first endpoint device 102a is configured to communicate with the second endpoint device over a corresponding inter-endpoint device communication channel 108a and so on such that the first endpoint device is configured to communicate with the nth endpoint device 102n over a corresponding inter-endpoint communication channel 108n. The communication channels 108a-108n between endpoint devices 102a-102n may be either quantum or classical communication channels. In the example shown in FIG. 2 and discussed below, the communication channels 108a-108n between endpoint devices 102a-102n are classical communication channels. The reason for this may, at least in part, be that the information communicated over said communication channels 108a-108n is encrypted with a fully quantum-secure encryption key and/or that the information cannot assist anyone outside of the two communicating parties using the communication channel in deriving the identity of the group encryption key, K₀.

In the SQKD system 200 of FIG. 2, the intermediary device/satellite 104 is not a trusted member of the group and may not, at any point during the group key agreement process, be privy to the identity of any information that would allow the intermediary device to derive the group encryption key, K₀. The intermediary device/satellite 104 is configured to agree, with each endpoint device 102a-102n, over the corresponding quantum communication channel 106a-1 to 106n-1 a respective QKD key using an appropriate QKD protocol—such as the one described below.

For each endpoint device 102a-102n, the intermediary device/satellite 104 is configured to create a bit string—this bit string is a respective random key, Kₙ, to be agreed with the corresponding endpoint device 102a-102n. The intermediary device/satellite 104 then transmits, to each endpoint device 102a-102n, the corresponding random key, Kₙ, using quantum transmissions over the quantum communication channel 106a-1 to 106n-1 between the intermediary device/satellite 104 and the respective endpoint device 102a-102n. Each quantum transmission of each bit will be made using a respective random set of transmitting bases, Bₙ. That is, for each bit of each random key, Kₙ, the intermediary device/satellite randomly chooses a basis in which to transmit said bit.

In the context of optical transmissions, the basis may correspond to a polarisation of a photon transmitted between the intermediary device/satellite 104 and the respective endpoint device 102a-102n. For example, the intermediary device/satellite 104 may choose between two or more bases. Said bases may be orthogonal and/or orthonormal. The bases may include the rectilinear basis, wherein a ‘0’ is encoded as a horizontally polarised photon and a ‘1’ is encoded as a vertically polarised photon (or vice versa); the diagonal basis, wherein a ‘0’ is encoded as a photon polarised with an angle between −90° and 90°—e.g., 45° and a ‘1’ is encoded as a photon polarised with a different angle between −90° and 90°—e.g., −45° (or vice versa; noting that other angle choices are possible—e.g., 30° and) 60°; and the circular basis, wherein a ‘0’ is encoded as a right-polarised photon and a ‘1’ is encoded as a left-polarised photon. Other basis states may also be used, for example an elliptical basis state may be used wherein ‘0’s and ‘1’s are encoded with orthogonal elliptical polarisations. An example of three orthonormal bases are set out in Table 1 below:

TABLE 1
Exemplary orthonormal bases that may be suitable for transmission and/or
reception of photons

| Basis | Bit = 0 | Bit = 1 |
|---|---|---|
| Rectilinear | Horizontal = \|0 [symbol] | Vertical = \|1 [symbol] |
| Diagonal | $+ 45 ° = \frac{1}{\sqrt{2}} ( \vert 0 〉 + \vert 1 〉 )$ | $- 45 ° = \frac{1}{\sqrt{2}} ( \vert 0 〉 - \vert 1 〉 )$ |
| Circular | $Right - polarised = \frac{1}{\sqrt{2}} ( \vert 0 〉 + i \vert 1 〉 )$ | $Left - polarised = \frac{1}{\sqrt{2}} ( \vert 0 〉 - i \vert 1 〉 )$ |

In some examples, some symbols (i.e., bits) of each random key, Kₙ, may be lost during transmission. Losses may occur, for example, due to the sensitivity of the corresponding quantum communication channel 106a-1 to 106a-n such that each endpoint device 102a-102n may receive a shorter string of bits than is transmitted by the intermediary device/satellite 104.

For receiving the bits of the respective random key, Kₙ, each endpoint device 102a-102n is configured to use a respective locally randomly generated set of bases, BₙU to choose a respective receiving basis in which each bit of the received string is received. Preferably, the set of different bases from which each receiving basis is selected is a matching set to those chosen by the intermediary device/satellite 104 for transmitting the respective random key, Kₙ. At any rate, there must be at least a partial overlap between the set of bases from which each endpoint device 102a-102n randomly selects the receiving bases, BₙU, and the set of bases from which the intermediary device/satellite 104 randomly selects the corresponding transmitting bases, Bₙ.

In some examples, each endpoint device 102a-102n may comprise, for example, an optical beam-splitter or other similar component capable of diverting the beam path of photons. One output of each optical beam-splitter may lead to a detector that is part of the respective endpoint device while the other output(s) lead to a beam path that terminates with another detector. This ensures a random selection of the transmitted bits of the respective random key, Kₙ, are successfully received by the endpoint device 102a-102n (i.e., detected by the detectors within the endpoint device 102a-102n, such that the pair of detectors can positively detect a 0 or 1 in the selected basis).

Each endpoint device 102a-102n may be configured to transmit an indication, In, of which symbols of the corresponding random key, Kₙ, were successfully received by the endpoint device 102a-102n. The indication, In, is sent over the classical communication channel 106b-1 to 106n-1 between the endpoint device 102a-102n and the intermediary device/satellite 104. Importantly, the indication, l₀, includes only a representation of which symbols (bits) of the corresponding random key, Kₙ, were successfully received by the endpoint device 102a-102n but does not include an indication of which basis, BₙU, was used by the endpoint device 102a-102n to measure the incoming photon, nor does it contain an indication of what bit value the endpoint device 102a-102n measured for any of the bits. In examples where the endpoint devices 102a-102n do not reveal, to the intermediary device/satellite 104 the basis states, BₙU, in which the incoming photons were measured, the intermediary device/satellite 104 is unable to determine the identity of the final QKD keys, Kₙ, that each of the endpoint devices 102a-102n agree upon. This may mean, for example, that the intermediary device/satellite 104 may be able to estimate (or guess) only a limited fraction of each of the final QKD keys, Kₙ—e.g., the intermediary device/satellite 104 may be able to estimate only approximately 50% of each of the final QKD keys, Kₙ. In this way, the security of the final group key is increased because the intermediary device/satellite 104 (or a third party that may hack the intermediary device) will never be able to obtain, with certainty, the QKD keys agreed upon by each of the endpoint devices 102a-102n.

On receipt of an indication, Iₙ, from one of the endpoint devices 102a-102n, of which symbols of the corresponding random key, Kₙ, were successfully received by said endpoint device 102a-102n, the intermediary device/satellite 104 may be configured to discard those bits from the random key, Kₙ, that were not validly received by the corresponding endpoint device 102a-102n to obtain a respective partial random key, KₙS. The intermediary device/satellite 104 then retrieves a partial set, BₙS, of the basis values corresponding to the basis values used to transmit the bits of the partial random key, KₙS—noting that the partial random key consists of the bits of the random key Kₙ that were successfully received by the endpoint device 102a-102n. The intermediary device/satellite 104 transmits this partial set of bases, BₙS, to the endpoint device 102a-102n over the corresponding classical communication channel 106a-2 to 106n-2.

After receiving the partial set of bases, BₙS, the respective endpoint device reconciles this partial set of bases, BₙS, with the receiving set of bases, BₙU, used to receive the bits of the partial random key, KₙS. For each bit the basis value from the partial set of bases, BₙS, will either match or not match the basis value from the receiving set of bases, BₙU. If the basis values for a bit do not match, then the endpoint device 102a-102n determines that said bit was not validly received and discards the invalidly received bit from the string defining the received random key. If the basis values for a bit do match, then the endpoint device 102a-102n determines that said bit was validly received and retains the bit as part of a respective final QKD key, KₙU. The invalidly received bits that are discarded by the endpoint device 102a-102n may be identified by performing a logical combination of the partial set of bases, BₙS, and the receiving set of bases, BₙU. The logical combination may, for example, be an XOR operation, or similar of the partial set of bases, BₙS, with the receiving set of bases, BₙU.

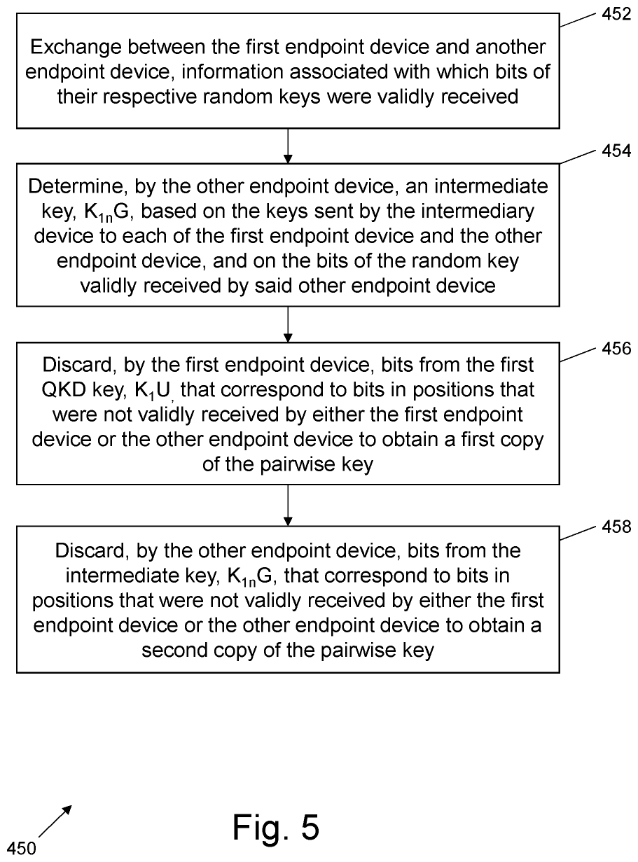

In order to establish a group key between the group of endpoint devices 102a-102b, one of the endpoint devices—in this case the first endpoint device 102a—creates the group key, K₀. In the system of FIG. 5a, the intermediary device/satellite 104 is not a trusted member of the group of endpoint devices 102a-102n. Therefore, it is necessary for the first endpoint device 102a to distribute the group key, K₀, without communicating any information to the intermediary device/satellite 104 that would enable the intermediary device/satellite 104 to derive the identity of the group key, K₀.

To achieve this, the intermediary device/satellite 104 is configured to send, to each of the endpoint devices 102b-102n other than the first endpoint device 102a, respective information that is useable by the corresponding endpoint device 102b-102n to derive the identity of the group key, K₀. Said information is hereinafter referred to as ‘group key information’.

For each endpoint device 102b-102n, the corresponding group key information may be based, at least in part, on the first partial key, K₁S, i.e., the partial key (derived as discussed above) on which the first QKD key, K₁U, associated with the first endpoint device 102a is based; and on the respective partial key KₙS, i.e., the partial key (derived as discussed above) on which the corresponding QKD key, KₙU, associated with the respective endpoint device 102b-102n is based. In some examples, the corresponding key information may be based on a combination of the first partial key, K₁S, and the respective partial key, KₙS. In some examples, the combination may be obtained by performing an XOR operation, or similar between the first partial key, K₁S, and the respective partial key, KₙS.

Meanwhile, the first endpoint device 102a is configured to agree, with each of the other endpoint devices 102b-102n a respective pairwise encryption key, K^{PW}₁ₙ, for encrypting messages between the first endpoint device 102a and the corresponding other endpoint device 102b-102n. The process for agreeing the pairwise key is discussed in more detail below in relation to FIGS. 5b and 5d.

Once the first endpoint device 102a has agreed a respective pairwise encryption key with the corresponding other endpoint device 102b-102n, the first endpoint device 102a is configured to encrypt a copy of the group key, K₀, with the respective pairwise encryption key and transmit the encrypted copy of the group key to the corresponding other endpoint device 102b-102n over the respective inter-endpoint device communication channel 108a-108n.

In the example shown in FIG. 5a, the first endpoint device 102a agrees a respective pairwise key with each of the other endpoint devices 102b so as to be able to securely transmit encrypted copies of the group key, K₀ from the first endpoint device 102a to each of the other endpoint devices 102b-102n. Additionally or alternatively, any of the endpoint devices 102a-102n may agree a respective pairwise key, K^{PW}ₘₙ, with any of the other endpoint devices 102a-102n (for example with a neighbouring endpoint device) such that any endpoint device in possession of the group key, K₀, may transmit an encrypted copy of the group key to another one of the endpoint devices. In this way, it may be possible to improve the efficiency of the distribution of the group key, K₀, for example through the implementation of a gossip network, or similar.

Upon receipt of the encrypted group key, each endpoint device 102a-102n is able to decrypt their copy of the group key by using their respective pairwise key that they agreed with the endpoint device from which they received the group key.

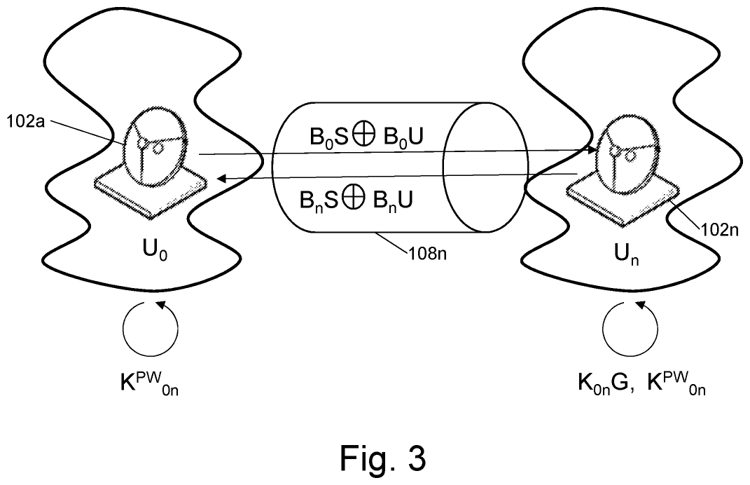

FIG. 3 is a schematic diagram illustrating the agreement of a pairwise key between two endpoint devices 102a, 102n, such as those depicted in FIG. 2.

As discussed above, in relation to FIG. 2, prior to agreeing the pairwise key, the first endpoint device 102a has determined:
(a) a string of bits, K₁U, defining the first QKD key;
(b) the receiving set of bases, B₁U, that were used to receive the string of bits associated with the first random key, K₁; and
(c) a combination of the receiving set of bases, B₁U, and the first partial set of bases, B₁S, that was used to derive the identity of the first QKD key.

As discussed above, the combination of the receiving set of bases, B₁U, and the first partial set of bases, B₁S, may be obtained by performing an XOR operation, or similar, between the receiving set of bases, B₁U, and the partial set of bases, B₁S.

Similarly, as discussed above in relation to FIG. 5a, prior to agreeing the pairwise key, the other endpoint device 102n has determined:
(a) a string of bits, KₙU, defining the corresponding QKD key;
(b) the receiving set of bases, BₙU, that were used to receive the string of bits associated with the corresponding random key, Kₙ;
(c) a combination of the receiving set of bases, BₙU, and the corresponding partial set of bases, BₙS, that was used to derive the identity of the corresponding QKD key; and
(d) respective group key information that is based on a combination of the first partial key, K₁S, and the corresponding partial key, KₙS, wherein the respective partial keys are the partial bit strings identified as the strings of bits which were successfully received by the corresponding endpoint devices, as discussed above.

As discussed above, the combination of the receiving set of bases, BₙU, and the corresponding partial set of bases, BₙU, may be obtained by performing an XOR operation, or similar, between the receiving set of bases, BₙU, and the partial set of bases, BₙS.

Further, as discussed above, the respective group key information may be obtained by performing an XOR operation, or similar, between the first partial key, K₁S, and the corresponding partial key, KₙS.

Based on each of the endpoint devices 102a, 102n having in their possession the above information, the first endpoint device 102a and the other endpoint device 102n are able to securely agree a pairwise key using the classical communication channel 108n therebetween.

The other endpoint device 102n is configured to determine a respective intermediate key, K₁ₙG, to be used in determining the pairwise key. The intermediate key, K₁ₙG, is based on a combination of the respective QKD key, KₙU, and the respective group key information. The combination of the respective QKD key and the respective group key information may be obtained by performing an XOR operation, or similar, between the respective QKD key and the respective group key information (i.e., K₁ₙG=K₁U XOR [K₁S XOR KₙS]).

The first endpoint device 102a and the other endpoint device 102n are further configured to exchange their combinations of basis sets. In other words, the first endpoint device 102a is configured to transmit the combination of the first receiving set of bases and the first partial set of bases to the other endpoint device 102n over the classical communication channel 108n therebetween; and the other endpoint device 102n is configured to transmit the combination of the respective receiving set of bases and the corresponding partial set of bases to the first endpoint device 102a.

The first endpoint device 102a and the other endpoint device 102b are then configured to determine a further combination of the recently exchanged basis combinations. In other words, both the first endpoint device 102a and the other endpoint device 102b are configured to determine a combination of the two bit strings defined by: (i) B₁S XOR B₁U and (ii) BₙS XOR BₙU. In contrasts to previous combinations of bit strings described above, the combination of the recently exchanged basis combinations is preferably a non-exclusive combination. A non-exclusive combination may, for example, be an OR operation, or similar, between the two exchange basis combinations, i.e. the non-exclusive combination may be a bit string defined by: [(B₁S XOR B₁U) OR (BₙS XOR BₙU)]. As discussed above, each combination of a receiving set of bases, BₙU, with a corresponding partial set of bases, BₙS is useable to identify the bits within the corresponding partial key, KₙS that were not validly received by the corresponding endpoint device 102a-102n. As such, a non-exclusive combination of the recently exchanged basis combinations is useable to identify, any bits that were not validly received by either the first endpoint device 102a and/or the other endpoint device 102b. In other words, the non-exclusive combination is useable to identify bits that were not validly received by at least one of the endpoint devices 102a, 102n attempting to agree a pairwise key therebetween.

The first endpoint device 102a determines its copy of the pairwise key, K^{PW}₁ₙ, by discarding from the first QKD key, K₁, any bits that were not validly received by either the first endpoint device 102a or the other endpoint device 102n. The first endpoint device 102a determines which bits were not validly received based on the non-exclusive combination described above.

Meanwhile, the other endpoint device 102n determines its copy of the pairwise key, K^{PW}₁ₙ, by discarding from the respective intermediate key, K₁ₙG, any bits that were not validly received by either the first endpoint device 102a or the other endpoint device 102n. The other endpoint device 102n determines which bits were not validly received based on the non-exclusive combination described above.

The process of agreeing a pairwise key as described above may be repeated between any pair of endpoint devices 102a-102n to facilitate secure two-party communication therebetween.

The resulting values of each of the copies of the pairwise key, K^{PW}₁ₙ, determined by each of the first and other endpoint device 102a, 102n will be the same if there were no errors or interception in the communication over the classical communication channel 108n therebetween. In some examples, the first endpoint device 102a and other endpoint device 108n may perform an error correction process to ensure that each endpoint device 102a, 102n possess an error-free copy of the pairwise key, K^{PW}₁ₙ. The error correction process may be based on standard techniques known to the person skilled in the art such as, for example, BB84 error correction or another similar process.

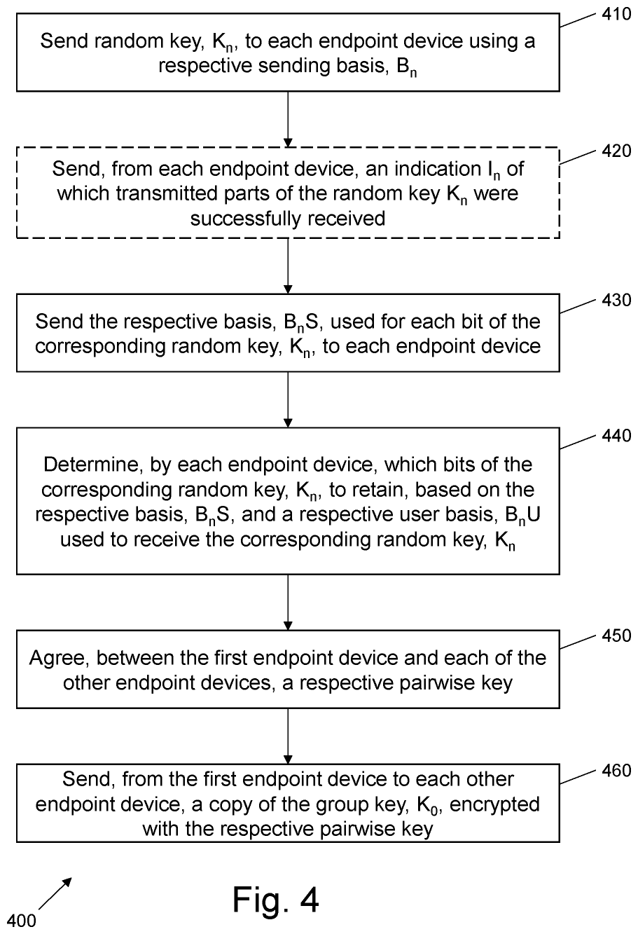

FIG. 4 is a flow diagram illustrating a QKD group key sharing process for use in the SQKD system of FIG. 2.

A first operation 410 comprises sending, from the intermediary device/satellite 104 to each of the endpoint devices 102a-102n, respective random keys, Kₙ, using respective randomly selected bases, Bₙ.

A further (optional) operation 420 comprises sending, from each endpoint device 102a-102n to the intermediary device/satellite 104 a respective indication, Iₙ, of which bits/symbols of the corresponding random key, Kₙ, were successfully received by said endpoint device 102a-102n.

Operation 430 comprises sending, from the intermediary device/satellite 104 to each endpoint device 102a-102n a partial basis set, BₙS, corresponding to a respective partial random key, KₙS. Each partial random key, KₙS, comprises only those bits that were successfully received by the corresponding endpoint device 102a-102n. Therefore the partial basis set, BₙS, comprises only those basis values indicative of the basis in which bits that were successfully received by the corresponding endpoint device 102a-102n were transmitted.

Operation 440 comprises each endpoint device determining a respective QKD key, KₙU, by determining which bits of the corresponding random key, Kₙ, were validly received (i.e., received in the correct basis) based on the respective partial basis set, BₙS, and the corresponding receiving basis set, BₙU, used to receive the corresponding random key, Kₙ. The determination may be based on a combination of the partial basis set and the receiving basis set, for example an XOR operation, or similar, of the partial basis set with the receiving basis set: BₙS XOR BₙU.

Operation 450 comprises agreeing between the first endpoint device 102a and each of the other endpoint devices 102b-102n respective pairwise encryption keys, K^{PW}₁ₙ. Operation 450 is discussed in more detail below in relation to FIG. 5.

FIG. 5 is a flow diagram illustrating a pairwise key agreement process (i.e., operation 450) for use between the endpoint devices 102a, 102n of FIG. 3.

A first sub-operation 452 comprises exchanging, between the first endpoint device 102a and the other endpoint device 102n information associated with which bits of their respective random keys were validly received. As discussed above, this information may be encoded as a bit string determined by performing an XOR operation between the respective partial basis set, BₙS, and the respective receiving basis set, BₙU, for each of the endpoint devices 102a, 102n.

A further sub-operation 454 comprises determining, by the other endpoint device 102n, an intermediate key, K₁ₙG, based on a combination of the partial keys, K₁S, KₙS, retrieved by the intermediary device/satellite that correspond to the bits of the random keys K₁, that were successfully received by each of the first endpoint device 102a and the other endpoint device 102n; and based on the QKD key, KₙU, determined by the other endpoint device 102n. As discussed above, this intermediate key may be determined as: K₁ₙG=KₙU XOR [K₁S XOR KₙS].

A further sub-operation 456 comprises discarding, by the first endpoint device 102a, bits from the first QKD key, K₁U, in positions corresponding to positions of bits that were not validly received by at least one of the first endpoint device 102a and the other endpoint device 102n to obtain a first copy of the pairwise key, K^{PW}₁ₙ.

A further sub-operation 458 comprises discarding, by the other endpoint device 102n, bits from the intermediate key, K₀₁G, in positions corresponding to positions of bits that were not validly received by at least one of the first endpoint device 102a, and the other endpoint device 102n to obtain a second copy of the pairwise key, K^{PW}₁ₙ.

Returning to FIG. 4, operation 460 comprises sending, from the first endpoint device 102a to each of the other endpoint devices 102b-102n a respective copy of the group key, K₀, wherein each copy of the group key is encrypted with the corresponding pairwise encryption key, K^{PW}₁ₙ.

As discussed above, in additional or alternative examples pairwise keys may be agreed between different or additional pairs of endpoint devices 102a-102n, provided that each endpoint device 102a-102n is able to obtain an encrypted copy of the group key, K₀, that they themselves are able to decrypt using an agreed pairwise encryption key, K^{PW}ₘₙ.

Once the group key, K₀, has been distributed amongst all of the endpoint devices 102a-102n of the group and decrypted using the relevant pairwise encryption key, K^{PW}ₘₙ, secure communications within the group may be enabled. In the examples described above in relation to FIGS. 2 to 5, the intermediary device/satellite 104 can only have a partial knowledge of the pairwise keys, the intermediary device/satellite 104 may only have a chance (for example a 50% chance) of correctly identifying the value of any given bit within each pairwise key. In this way, the information encrypted with each pairwise key may be made cryptographically (and mathematically) secure.

For illustrative purposes a detailed example of the methods described herein is presented below using initial transmitted keys having a bit length of 12 bits. The skilled person will, however, be aware that in most practical implementations the bit length of the keys transmitted from the intermediary device 104 to each of the endpoint devices 102a-102n will be significantly longer. For example, typical bit lengths may be 50 bits or more (e.g., 64 bits), 100 bits or more (e.g., 128 bits), 200 bits or more (e.g., 256 bits), or 500 bits or more (e.g., 512 bits).

In the example described below, only two endpoint devices 102a, 102b are considered—for illustrative purposes. As the skilled person will appreciate, the method and system exemplified in the discussion may be extended to a system comprising any number of endpoint devices 102a-102n.

In a first operation (operation 410 of FIG. 4), the intermediary device 104 sends a first encryption key, K₁, to the first endpoint device 102a, and a second encryption key, K₂, to the second endpoint device 102b. In the present example:

$${K}_{1} = 101100110010$$

$${K}_{2} = 111000110100$$

In a further operation, (operation 420 of FIG. 4), each of the endpoint devices 102a, 102b sends a respective indication, In, of which transmitted parts of the corresponding encryption key, Kₙ, were successfully received by the endpoint device 102a, 102b. The indication may take the form of a bit string having the same length as the encryption keys sent from the intermediary device 104 to the endpoint devices 102a. In such a bit string, a ‘1’ may indicate that the bit of the encryption key in the position corresponding to that of the ‘1’ in the indication has been successfully received. Similarly, a ‘0’ may indicate that the bit of the encryption key in the position corresponding to that of the ‘0’ in the indication has not been successfully received. As discussed above, each of the endpoint devices 102a, 102b may comprise an optical beamsplitter or similar. The provision of a beamsplitter may facilitate the successful transmission of a random selection of approximately 50% of the bits of the encryption key, Kₙ, transmitted by the intermediary device 104 to the respective endpoint device 102a, 102b. In the present example, the first endpoint device 102a sends a first indication, I₁, to the intermediary device 104; and the second endpoint device 102b sends a second indication, I₂, to the intermediary device, wherein:

$${I}_{1} = 001111010100$$

$${I}_{2} = 101110000011$$

These indications may be interpreted as: the first endpoint device 102a indicates to the intermediary device 104 that the third, fourth, fifth, sixth, eighth, and tenth bits of the first encryption key, K₁, were successfully received by the first endpoint device 102a; and the second endpoint device 102b indicates to the intermediary device 104 that the first, third, fourth, fifth, eleventh, and twelfth bits of the second encryption key, K₂, were successfully received by the second endpoint device 102b.

In a further operation, the intermediary device 104 discards, from each of the encryption keys, Kₙ, the bits that were indicated as not being validly received to obtain respective successfully sent encryption keys, KₙS. In the present example, the intermediary device 104 discards the first, second, seventh, ninth, eleventh, and twelfth bits from the first encryption key, K₁, and discards the second, sixth, seventh, eighth, ninth and tenth bits from the second encryption key, K₂ to obtain:

$${K}_{1} S = 110010$$

$${K}_{2} S = 110000$$

As discussed above, each bit of each of the encryption keys is transmitted in a respective basis. In this and other examples, this basis may be randomly selected from a set of possible bases. In this example, the intermediary device 104 may transmit a bit in either the rectilinear basis, or in the diagonal basis.

In a further operation (operation 430 of FIG. 4), the intermediary device 104 sends to each of the endpoint devices 102a, 102b a respective set of transmitting bases, BₙS, used to transmit the corresponding encryption key to each endpoint device 102a, 102b. In some examples, the sets of transmitting bases, BₙS, may only comprise information indicative of the bases in which bits that were successfully received by the endpoint devices 102a, 102b were sent.

In some examples, the sets of transmitting bases may be communicated as bit strings, wherein the value of each bit serves as an indicator of which basis the corresponding bit of the respective encryption key was sent. For example, a ‘1’ may indicate that the corresponding bit of the respective encryption key was sent in the rectilinear basis, and a ‘0’ may indicate that the corresponding bit of the respective encryption key was sent in the diagonal basis. In this example, the intermediary device 104 sends a first set of transmitting bases, B₁S, to the first endpoint device 102a and sends a second set of transmitting bases, B₂S, to the second endpoint device 102b, wherein:

$${B}_{1} S = 111000$$

$${B}_{2} S = 101010$$

This may be interpreted as: the intermediary device 104 sends the first, second, and third bits of the first successfully sent encryption key, K₁S, in the rectilinear basis, and the fourth, fifth and sixth bits of the first successfully sent encryption key, K₁S, in the diagonal basis; and the intermediary device 104 sends the first, third and fifth bits of the second successfully sent encryption key, K₂S, in the rectilinear basis, and the second, fourth and sixth bits of the second successfully sent encryption key, K₂S in the diagonal basis.

As discussed above, each endpoint device 102a, 102b receives each bit of its respective received encryption key in a respective basis chosen from a predetermined set of bases. This set of bases must have at least some of the same members as the set of bases from which the transmitting bases were selected by the intermediary device 104. In this example, the endpoint devices 102a, 102b randomly select each of the receiving bases as being either the rectilinear basis or diagonal basis. In this way, for each endpoint device 102a, 102b, the respective set of receiving bases, BₙU, may be encoded as a bit string, wherein the value of each bit serves as an indicator of which basis the corresponding bit of the respective encryption key was received in. For example, a ‘1’ may indicate that the corresponding bit of the respective encryption key was received in the rectilinear basis, and a ‘0’ may indicate that the corresponding bit of the respective encryption key was received in the diagonal basis. In this example:

$${B}_{1} U = 101100$$

$${B}_{2} U = 111010$$

This may be interpreted as: the first endpoint device 102a receives the first, third and fourth bits of its respective encryption key in the rectilinear basis, and the second, fifth and sixth bits in the diagonal basis; and the second endpoint device 102b receives the first, second, third and fifth bits of its respective encryption key in the rectilinear basis, and the fourth and sixth bits in the diagonal basis. The encryption keys received by the first and second endpoint devices 102a, 102b may be expressed respectively as:

$${K}_{1} U = ( \begin{matrix}α & β & γ & δ & ϵ & ζ\end{matrix} )$$

$${K}_{2} U = ( \begin{matrix}η & θ & ι & κ & λ & μ\end{matrix} )$$

Each of α, β, γ, δ, ε, ζ, η, θ, ι, κ. λ, and u may take a value of ‘0’ or ‘1’ depending on the bases in which the bit was transmitted and received.

In a further operation (operation 440 of FIG. 4), each endpoint device 102a, 102b determines which bits of the respectively received keys, KₙU, were received in the same basis as in which they were transmitted. These bits may be referred to as ‘validly received’ bits. The positions of bits within the respectively received key, KₙU, that were validly received may be determined by performing a combination of the respective set of transmitted bases with the respective set of received bases, for example by performing an XOR operation therebetween. In this example:

$${B}_{1} S XOR {B}_{1} U = 010100$$

$${B}_{2} S XOR {B}_{2} U = 010000$$

This may be interpreted as: the first endpoint device 102a validly receives the first, third, fifth and sixth bits of the first encryption key; and the second endpoint device 102b validly receives the first, third, fourth, fifth and sixth bits of the second encryption key.

Based on the identification of the validly received bits, the values of some of the bits in each of the first and second received encryption keys may be determined (by an omniscient observer) as:

$$α = 1 ; β = \{ \begin{matrix}0 & 50 \% \\ 1 & 50 \%\end{matrix} ; γ = 0 ; δ = \{ \begin{matrix}0 & 50 \% \\ 1 & 50 \%\end{matrix} ; ϵ = 1 ; ζ = 0$$

$$η = 1 ; θ = \{ \begin{matrix}0 & 50 \% \\ 1 & 50 \%\end{matrix} ; ι = 0 ; κ = 0 ; λ = 0 ; μ = 0$$

In this example, the first endpoint device 102a generates a group key for communication between the first and second endpoint devices 102a, 120b. To securely and secretly distribute this group key, the first and second endpoint devices 102a, 102b, in a further operation (operation 450 of FIG. 4), agree a pairwise key between themselves. The agreement of the pairwise key may be carried out over the course of multiple sub-operations.

In a sub-operation (sub-operation 452 in FIG. 5), the first and second endpoint devices 102a, 102b exchange information about which bits in their respective encryption keys were validly received. This information may take the form of the combined bit strings listed above —B₁S⊗B₁U is sent from the first endpoint device 102a to the second endpoint device 102b, and B₂S⊗B₂U is sent from the second endpoint device 102b to the first endpoint device 102a.

In another sub-operation, the intermediary device 104 sends, to the second endpoint device 102b, pairwise key information. The pairwise key information may be based on the successfully sent keys sent to the first and second endpoint devices 102a, 102b—K₁S, K₂S. In particular, the pairwise key information may be a combination (for example via an XOR operation) of the first successfully sent encryption key and the second successfully sent encryption keys:

$${K}_{1} S XOR {K}_{2} S = 000010$$

In a further sub-operation, the second endpoint device 102b determines an intermediate key, K₁₂G, based on the received pairwise key information and the received second encryption key, K₂U. The intermediate key may be a combination of the received second encryption key with the received pairwise key information. Said combination may be obtained, for example, by performing an XOR operation therebetween. In this example, therefore:

$${K}_{12} G = {K}_{2} U XOR ( {K}_{1} S XOR {K}_{2} S )$$

$${K}_{12} G = ( \begin{matrix}η XOR 0 \\ θ XOR 0 \\ ι XOR 0 \\ κ XOR 0 \\ λ XOR 1 \\ μ XOR 0\end{matrix} )$$

In a further sub-operation (sub-operations 456 and 458 of FIG. 5), the first and second endpoint devices discard, from the first received encryption key, K₁U, and the intermediate key, K₁₂G respectively bits that are in positions corresponding to the positions of bits that were not validly received by either the first or second endpoint device when receiving their respective encryption keys. In order to determine which bits to discard, the first and second endpoint devices 102 may perform a non-exclusive combination (e.g., an OR operation) between the first set of validly received bit positions and the second set of validly received bit positions. In this example, this may be expressed as:

$$( {B}_{1} S XOR {B}_{1} U ) OR ( {B}_{2} S XOR {B}_{2} U ) = ( 010100 ) OR ( 010000 ) = 010100$$

This may be interpreted as: the first endpoint device 102a determines that the second and fourth bits be discarded from the first received encryption key, and the second endpoint device 102b determines that the second and fourth bits be discarded from the intermediate key, K₁₂G. Accordingly, the first endpoint device 102a obtains a first copy of the pairwise key:

$${K}_{1}^{PW} = α γ ϵ ζ = 1010$$

while the second endpoint device 102b obtains a second copy of the pairwise key:

$${K}_{2}^{PW} = η XOR 0 ι XOR 0 λ XOR 1 μ XOR 0 = 1010$$

In this way it can be seen that both the first and second endpoint devices 102a, 102b obtain identical copies of the pairwise key without the intermediary device 104 (or any other device) ever obtaining enough information to be able to derive the identity of the pairwise key, and without either of the first or second endpoint devices 102a, 102b being able to determine the identity of the respectively received encryption keys received at the other of the endpoint devices.

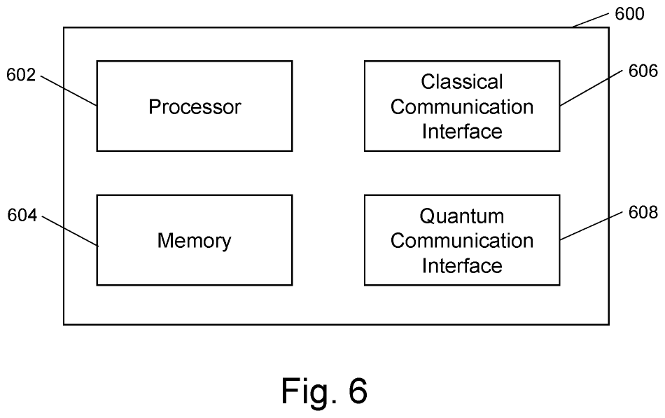

FIG. 6 is a schematic diagram illustrating an example computing device 600 configured to implement the methods described herein.

Computing device 600 comprises one or more processors 602, memory 604 and classical and quantum communication interfaces 606, 608. The computing device 600 may further comprise a random number generator or similar (not pictured) to facilitate generating random strings of bits to act as the random keys, Kₙ. The processor 602 may comprise executable logic that, when executed by the processor 602, causes the computing device 600 to carry out steps of the methods described herein. The memory 604 may be used to store information, for example the keys, basis sets, and group key information described above. The classical communication interface 606 may be configured for communicating over classical communications networks and/or satellite networks and the quantum communication interface 608 may be configured for communicating over quantum communication channels, for example using optical channels or other types of quantum channel. The communication interfaces 606, 608 may facilitate the communication of the keys, basis sets and group key information described above to enable the methods described herein.

In the embodiments described above, the server may comprise a single server or network of servers. In some examples, the functionality of the server may be provided by a network of servers distributed across a geographical area, such as a worldwide distributed network of servers, and a user may be connected to an appropriate one of the network servers based upon, for example, a user location.

The embodiments described above are fully automatic. In some examples a user or operator of the system may manually instruct some steps of the method to be carried out.

In the described embodiments of the invention the system may be implemented as any form of a computing and/or electronic device. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

Various functions described herein can be implemented in hardware, software, or any combination thereof. If implemented in software, the functions can be stored on or transmitted over as one or more instructions or code on a computer-readable medium. Computer-readable media may include, for example, computer-readable storage media. Computer-readable storage media may include volatile or non-volatile, removable or non-removable media implemented in any method or technology for storage of information such as computer readable instructions, data structures, program modules or other data. A computer-readable storage media can be any available storage media that may be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer. Disc and disk, as used herein, include compact disc (CD), laser disc, optical disc, digital versatile disc (DVD), floppy disk, and Blu-ray (RTM) disc (BD). Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fibre optic cable, twisted pair, DSL, or wireless technologies such as infrared, radio, and microwave are included in the definition of communication medium. Combinations of the above should also be included within the scope of computer-readable media.

Alternatively, or in addition, the functionality described herein can be performed, at least in part, by one or more hardware logic components. For example, and without limitation, hardware logic components that can be used may include Field-programmable Gate Arrays (FPGAs), Program-specific Integrated Circuits (ASICs), Program-specific Standard Products (ASSPs), System-on-a-chip systems (SOCs). Complex Programmable Logic Devices (CPLDs), etc.

Although illustrated as a single system, it is to be understood that the computing device may be a distributed system. Thus, for instance, several devices may be in communication by way of a network connection and may collectively perform tasks described as being performed by the computing device.

Although illustrated as local devices it will be appreciated that the computing devices may be located remotely and accessed via a network or other communication link (for example using a communication interface).

The term ‘computer’ is used herein to refer to any device with processing capability such that it can execute instructions. Those skilled in the art will realise that such processing capabilities are incorporated into many different devices and therefore the term ‘computer’ includes PCs, servers, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages. Variants should be considered to be included into the scope of the invention.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, to the extent that the term “includes” is used in either the detailed description or the claims, such term is intended to be inclusive in a manner similar to the term “comprising” as “comprising” is interpreted when employed as a transitional word in a claim.

Moreover, the acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

1-39. (canceled)

40. A computer-implemented method of generating a group key for a group of endpoint devices in a communication system comprising the group of endpoint devices and an intermediary device, the intermediary device being communicatively linked to each of the endpoint devices by a respective quantum communication channel and a respective classical communication channel, the method comprising:
sending, from the intermediary device to each of the endpoint devices, over the corresponding quantum communication channel a respective encryption key, said respective encryption key being defined by a string of bits,
wherein each bit of each encryption key is transmitted in a randomly selected basis state such that for each encryption key there is a corresponding set of transmitting bases indicative of the basis in which each bit of said encryption key was sent to the corresponding endpoint device;
receiving, at each endpoint device, the respective encryption key,
wherein each bit of the respective received encryption key is received in a randomly selected basis state such that there is a corresponding set of receiving bases indicative of the basis in which each bit of the respective received encryption key was received by the corresponding endpoint device;
sending, from the intermediary device to each of the endpoint devices, over the corresponding classical communication channel the respective set of transmitting bases corresponding to the respective encryption key;
determining, by each endpoint device, a set of bits of the encryption key that were validly received based on a combination of the respective set of transmitting bases and the respective set of receiving bases;
determining, by one of the endpoint devices, a group key, K₀; and
iteratively distributing the group key, wherein each iteration of the distributing comprises:
agreeing, between an endpoint device in possession of the group key and another endpoint device not in possession of the group key, a respective pairwise encryption key, wherein the agreeing of the pairwise encryption key is based on:
the respective sets of transmitting bases corresponding to each of the endpoint device in possession of the group key and the endpoint device not in possession of the group key,
the respective sets of receiving bases corresponding to each of the endpoint device in possession of the group key and the endpoint device not in possession of the group key, and
the respective encryption keys received by each of the endpoint device in possession of the group key and the endpoint device not in possession of the group key;
encrypting, by said endpoint device in possession of the group key, a copy of the group key with the respective pairwise encryption key; and
sending, from said endpoint device in possession of the group key to said endpoint device not in possession of the group key, the encrypted copy of the group key.

41. The computer-implemented method according to claim 40, wherein determining the set of bits of the encryption key that were validly received comprises:
combining the respective set of transmitting bases and the respective set of receiving bases by performing an XOR operation between the set of transmitting bases and the set of receiving bases.

42. The computer-implemented method according to claim 40, wherein agreeing, between a first and second endpoint device, a pairwise encryption key comprises:
receiving, at the second endpoint device from the intermediary device, pairwise key information based on:
information associated with the encryption key sent from the intermediary device to the first endpoint device, and
information associated with the encryption key sent from the intermediary device to the second endpoint device;
determining, at the second endpoint device, an intermediate key based on the pairwise key information and the respective encryption key received from the intermediary device by the second endpoint device;
exchanging, between the first and second endpoint devices, over a communication channel communicatively linking the first and second endpoint devices, the respectively determined set of bits of the corresponding encryption key that were validly received by each of the endpoint devices;
discarding, by the first endpoint device, bits from the respective encryption key received from the intermediary device that are in positions within the respective encryption key corresponding to the positions of the bits in their respective encryption keys that were not validly received by either the first endpoint device or the second endpoint device to obtain a first copy of the pairwise encryption key; and
discarding, by the second endpoint device, bits from the intermediate key that are in positions within the intermediate key corresponding to the positions of the bits in their respective encryption keys that were not validly received by either the first endpoint device or the second endpoint device to obtain a second copy of the pairwise encryption key.

43. The computer-implemented method according to claim 42, wherein the pairwise key information comprises a combination of information indicative of the encryption key sent to the first endpoint device by the intermediary device and information indicative of the encryption key sent to the second endpoint device by the intermediary device.

44. The computer-implemented method according to claim 43, wherein the combination of information indicative of the encryption key sent to the first endpoint device by the intermediary device and information indicative of the encryption key sent to the second endpoint device by the intermediary device comprises a bit string obtainable by performing an XOR operation between the encryption key sent to the first endpoint device and the encryption key sent to the second endpoint device.

45. The computer-implemented method according to claim 42, wherein determining the intermediate key, by the second endpoint device, comprises combining the respective encryption key received from the intermediary device with the pairwise key information received from the intermediary device.

46. The computer-implemented method according to claim 45, wherein combining the respective encryption key received by the second endpoint device with the pairwise key information received from the intermediary device comprises performing an XOR operation between said encryption key and the pairwise key information.

47. The computer-implemented method according to claim 42, further comprising, after exchanging the respectively determined set of bits of the corresponding encryption key that were validly received by each of the endpoint devices:
determining, by each of the first and second endpoint device, a set of positions within the respective encryption key or intermediate key, corresponding to one or both of:
(i) positions within the encryption key received by the first endpoint device from the intermediary device that are the positions of bits in said encryption key that were not validly received by the first endpoint device; and
(ii) positions within the encryption key received by the second endpoint device from the intermediary device that are the positions of bits in said encryption key that were not validly received by the second endpoint device, and
wherein the discarding, by each of the endpoint devices, of bits from the respective encryption key or intermediate key comprises discarding bits that are in the determined set of positions.

48. The computer-implemented method according to claim 47, wherein determining the set of positions comprises performing a non-exclusive combination of the determined set of bits of the encryption key received by the first endpoint device that were validly received with the determined set of bits of the encryption key received by the second endpoint device that were validly received.

49. The computer-implemented method according to claim 48, wherein the non-exclusive combination is a logical OR operation.

50. The computer-implemented method according to claim 40, wherein a bit is determined as being validly received if it was received in the same basis as the basis in which it was transmitted by the intermediary device.

51. The computer-implemented method according to claim 40, wherein each quantum communication channel is a lossy channel, and the method further comprises:
sending, from each of the endpoint devices, a respective indication of which bits of the respective encryption key were successfully transmitted over the corresponding quantum communication channel; and
before sending the respective set of transmitting bases from the intermediary device to each of the endpoint devices, modifying the respective encryption key by discarding bits corresponding to those bits that were not successfully transmitted over the quantum communication channel, such that all further operations by the intermediary device based on the respective encryption key are based on the modified respective encryption key.

52. A computer-implemented method for generating a group key for a group of endpoint devices in a communication system, the method being performable by an endpoint device in the group, said endpoint device being communicatively linked to an intermediary device by a quantum communication channel and a classical communication channel, the method comprising:
receiving, from the intermediary device, over the quantum communication channel, an encryption key, said encryption key being defined by a string of bits,
wherein each bit of the encryption key is transmitted in a randomly selected basis state such that there is a corresponding set of transmitting bases indicative of the basis in which each bit of the encryption key was sent to the endpoint device, and
wherein each bit of the encryption key is received in a randomly selected bases state such that there is a corresponding set of receiving bases indicative of the basis in which each bit of the encryption key was received by the endpoint device;
receiving, from the intermediary device, over the classical communication channel, the set of transmitting bases corresponding to the encryption key;
determining a set of bits of the encryption key that were validly received based on a combination of the set of transmitting bases and the set of receiving bases;
optionally, determining a group key, K0; and
either:
if not in possession of the group key:
agreeing with a further endpoint device in the group of endpoint devices in possession of the group key, a pairwise encryption key, and
receiving from the further endpoint device, an encrypted copy of the group key, encrypted with the pairwise encryption key;
or:
if in possession of the group key: iteratively distributing the group key, wherein each iteration of the distributing comprises:
agreeing, with respectively further endpoint devices in the group of endpoint devices that are not in possession of the group key, a respective pairwise encryption key, wherein the agreeing of the pairwise encryption key is based on:
the respective sets of transmitting bases corresponding to each of the endpoint device in possession of the group key and the endpoint device not in possession of the group key,
the respective sets of receiving bases corresponding to each of the endpoint device in possession of the group key and the endpoint device not in possession of the group key, and
the respective encryption keys received by each of the endpoint device in possession of the group key and the endpoint device not in possession of the group key;
encrypting a copy of the group key with the respective pairwise encryption key, and
sending, to the respective further endpoint device, the respective encrypted copy of the group key.

53. The computer-implemented method according to claim 52, wherein determining the set of bits of the encryption key that were validly received comprises: combining the set of transmitting bases and the set of receiving bases by performing an XOR operation between the set of transmitting bases and the set of receiving bases.

54. The computer-implemented method according to claim 52, wherein agreeing between the endpoint device and the respective further endpoint device, a pairwise encryption key comprises:
exchanging, with the further endpoint device, over a communication channel communicatively linking the endpoint device with the further endpoint device, the determined set of bits of the encryption key that were validly received by the endpoint device and a further set of bits of the further encryption key that were determined by the further endpoint device as being validly received by the further endpoint device from the intermediary device; and
if the endpoint device is not in possession of the group key:
receiving, from the intermediary device, pairwise key information based on:
information associated with a further encryption key sent from the intermediary device to the further endpoint device, and
information associated with the encryption key received from the intermediary device;
determining an intermediate key based on the pairwise key information and the received encryption key; and
discarding bits from the intermediate key that are in positions within the intermediate key corresponding to the positions, within one or both of the encryption key and the further encryption key, of the bits that were not validly received by either or both of the endpoint device and the further endpoint device, to obtain a copy of the pairwise encryption key; or
if the endpoint device is in possession of the group key:
discarding bits from the received encryption key that are in positions within the encryption key corresponding to the positions, within one or both of the encryption key and the further encryption key, of the bits that were not validly received by either or both of the endpoint device and the further endpoint device, to obtain a copy of the pairwise encryption key.

55. The computer-implemented method according to claim 54, wherein the pairwise key information comprises a combination of information indicative of the encryption key sent to the endpoint device by the intermediary device and information indicative of the further encryption key sent to the further endpoint device by the intermediary device.

56. The computer-implemented method according to claim 55, wherein the combination of information indicative of the encryption key sent to the endpoint device by the intermediary device and information indicative of the further encryption key sent to the further endpoint device by the intermediary device comprises a bit string obtainable by performing an XOR operation between the encryption key sent to the endpoint device and the further encryption key sent to the further endpoint device.

57. The computer-implemented method according to claim 54, wherein determining the intermediate key comprises combining the received encryption key with the pairwise key information.

58. The computer-implemented method according to claim 57, wherein combining the received encryption key with the pairwise key information comprises performing an XOR operation between the received encryption key and the pairwise key information.

59. A computer-readable medium comprising instructions that, when executed by one or more computers, cause the one or more computers to carry out a method of generating a group key for a group of endpoint devices in a communication system, the method being performable by an endpoint device in the group, said endpoint device being communicatively linked to an intermediary device by a quantum communication channel and a classical communication channel, the method comprising:
receiving, from the intermediary device, over the quantum communication channel, an encryption key, said encryption key being defined by a string of bits,
wherein each bit of the encryption key is transmitted in a randomly selected basis state such that there is a corresponding set of transmitting bases indicative of the basis in which each bit of the encryption key was sent to the endpoint device, and
wherein each bit of the encryption key is received in a randomly selected bases state such that there is a corresponding set of receiving bases indicative of the basis in which each bit of the encryption key was received by the endpoint device;
receiving, from the intermediary device, over the classical communication channel, the set of transmitting bases corresponding to the encryption key;
determining a set of bits of the encryption key that were validly received based on a combination of the set of transmitting bases and the set of receiving bases;
optionally, determining a group key, K0; and
either:
if not in possession of the group key:
agreeing with a further endpoint device in the group of endpoint devices in possession of the group key, a pairwise encryption key, and
receiving from the further endpoint device, an encrypted copy of the group key, encrypted with the pairwise encryption key;
or:
if in possession of the group key: iteratively distributing the group key, wherein each iteration of the distributing comprises:
agreeing, with respectively further endpoint devices in the group of endpoint devices that are not in possession of the group key, a respective pairwise encryption key, wherein the agreeing of the pairwise encryption key is based on:
the respective sets of transmitting bases corresponding to each of the endpoint device in possession of the group key and the endpoint device not in possession of the group key,
the respective sets of receiving bases corresponding to each of the endpoint device in possession of the group key and the endpoint device not in possession of the group key, and
the respective encryption keys received by each of the endpoint device in possession of the group key and the endpoint device not in possession of the group key;
encrypting a copy of the group key with the respective pairwise encryption key, and
sending, to the respective further endpoint device, the respective encrypted copy of the group key.
